(19) United States
(12) Patent Application Publication
(10) Pub. No.: US 2025/0306811 A1
(43) Pub. Date: Oct. 2, 2025

(54) SYSTEM AND METHOD OF IMAGE APPORTIONMENT FOR CUSTOMIZED PRINTING

(71) Applicant: Kenneth Flower, Fremont, OH (US)

(72) Inventor: Kenneth Flower, Fremont, OH (US)

(21) Appl. No.: 19/088,145

(22) Filed: Mar. 24, 2025

Related U.S. Application Data
(60) Provisional application No. 63/571,181, filed on Mar. 28, 2024.

(51) Int. Cl. G06F 3/12

(52) U.S. Cl. CPC G06F 3/1208; G06F 3/1256

(57) ABSTRACT

A system and method for cropping digital images in the manufacturing of customized printed products is provided. The system includes a processor and memory, the memory including modules for receiving an image and an identified parameter, determining a die-line file and an image file, and creating a real-time preview with a superimposed image file on the die-line file. The system allows a user to establish a crop boundary through a graphical user interface (GUI) module, utilizing a movable endpoint within a geometric element. The system records a line segment along the path of the movable endpoint, and overlays shading on the image to designate an area to be cropped, producing an optimized die-line file and image file for printing. The system also utilizes artificial intelligence to enhance the accuracy of manually cropping an image for a personalized product design without requiring extensive technical knowledge or precise manual intervention.

### CROSS-REFERENCE TO RELATED APPLICATIONS

This application claims the benefit of U.S. Provisional Application No. 63/571,181, filed on Mar. 28, 2024. The entire disclosure of the above application is incorporated herein by reference.

### FIELD

The present technology relates to digital image processing for product customization and, more particularly, to systems and methods for automated and user-guided cropping of images in the creation of personalized printed products.

### INTRODUCTION

This section provides background information related to the present disclosure which is not necessarily prior art.

In the field of custom product creation, particularly concerning personalized printed items, image preparation is integral yet challenging. Image preparation may incorporate manual adjustment of digital images to align aspects of the images with predefined templates specific to products like air fresheners, labels, and stickers. This manual approach may be time-consuming and may demand substantial human resources and expertise to ensure the images are accurately aligned with the dimensions of the product and its configurations. As order volumes increase, manual cropping of images can lead to inconsistencies in the final product, impacting quality and uniformity.

Other custom printing processes may lack flexibility in image cropping tools available to users. By offering only a limited range of predefined shapes and sizes for cropping, for example, the ability of the user to fully customize the product is restricted, thereby significantly hindering creative control over custom product design. For a user seeking precise customization or having a distinct design idea, the rigidity of these tools can pose significant complications. Therefore, a user with a specific design idea in mind may find it difficult to realize their vision due to these limitations. Other systems that offer enhanced flexibility often suffer from complex interfaces that require technical acumen, thus alienating a user who might lack such expertise. Lacking an intuitive interface may make custom printing less accessible to the general public.

Compounding these issues can be the absence of adequate real-time feedback mechanisms in certain image customization tools. Such tools may require a user to frequently modify image crops through a labor-intensive process characterized by iterative adjustments, as there is little to no immediate visual feedback to gauge the impact of their adjustments. In other words, the user may not see the effects of their adjustments as they make them, which can lead to a trial-and-error approach that is inefficient and frustrating. Providing effective feedback mechanisms may reduce design time and enhance user satisfaction by allowing the user to immediately visualize changes, thereby avoiding inefficient trial-and-error methods that extend the production timeline.

Certain image processing and printing systems may not effectively utilize advancements in machine learning and artificial intelligence to assist in the image cropping process, even if the cropping process is predominantly manually executed. Despite the potential benefits of these technological advancements in the domain of image processing, integration of machine learning and artificial intelligence into custom printing systems remains minimal. Other systems may lack the proper components and technical capacity to autonomously identify primary image subjects or suggest optimal cropping boundaries in real-time as the user crops the image, tasks that could be significantly expedited and simplified through intelligent automation. Deficiencies in such technologies may result in burdensome manual labor for tasks that could otherwise see substantial automation, enhanced efficiency, and improved speed. As a result, a user is often left to manually perform tasks that could be streamlined through intelligent automation.

There is a continuing need for an improved method and system for cropping images in the production of customized printed products. Desirably, such a method and system would provide an intuitive graphical user interface (GUI) module that allows for flexible and precise image cropping, real-time visual feedback, and the integration of machine learning and artificial intelligence to streamline the customization process.

### SUMMARY

In concordance with the instant disclosure, improved methods and systems for cropping images in the production of customized printed products, which provide an intuitive GUI module that allow for flexible and precise image cropping, real-time visual feedback, and the integration of machine learning and artificial intelligence to streamline the customization process, have surprisingly been discovered.

The present technology includes systems and methods that relate to the creation, editing, and preparation of digital images for customized printing on various products, incorporating manually guided cropping and machine learning algorithms to streamline the design-to-production workflow. Ways are provided that allow a user to upload an image to a GUI module and manually crop the image with the use of a cursor. The user may establish an anchored endpoint adjacent to a crop boundary of the image and manually move a movable endpoint around the crop boundary. The system may display a line segment extending from the anchored endpoint to the movable endpoint. A shading may be overlaid on the image in real time as the user moves the movable endpoint along a path indicating an area of the image to be cropped and printed on a product blank.

In certain embodiments, a system is provided for cropping an image by a user, where the image is to be printed on a product blank. The system may include a processor and a memory, where the memory may be in communication with the processor. The memory may include a communication module that may be configured to receive the image to be printed on the product blank and an identified parameter of the image for the product blank. The memory may include an apportionment module that may determine a die-line file and an image file to be printed on the product blank. The die-line file may include a die-line perimeter and a die-line file surface area. The image file may include an image file perimeter and an image file surface area. The memory may include a path recording module that may record a path of the movable endpoint corresponding to a tracing by the user of the crop boundary. The path may include a line segment extending from the anchored endpoint to the movable endpoint. The memory may include a shading overlay module that may overlay a shading on the image in real time as the user moves the movable endpoint along the path. The memory may include an artificial intelligence module that may center the geometric element on the crop boundary.

In certain embodiments, the memory may include a GUI module. The GUI module may display a preview of the die-line file and the image file in real-time. The GUI module may display a superimposition of the image file surface area on the die-line file surface area such that the image file perimeter is bounded entirely by the die-line perimeter. The GUI module may include a cursor that may allow the user to establish an anchored endpoint adjacent to a crop boundary of the image. The cursor may allow the user to manually move a movable endpoint around the crop boundary. The GUI module may include a geometric element displayable on the GUI module that may be movable using the cursor. The movable endpoint may be automatically positioned within the geometric element. Alternatively, the geometric element may be manually centered over the crop boundary by the user and is movable using the cursor.

In certain embodiments, the memory may include a border generation module that may generate a border extending outwardly from the image file perimeter by a predetermined distance. The border may include an area between the image file perimeter and the die-line perimeter. The border generation module may generate a plurality of borders of predetermined widths. The border generation module may allow the user to alter the border in real-time. The border generation module may incorporate a decorative pattern within the area between the image file perimeter and the die-line perimeter.

In certain embodiments, a method is provided for cropping an image by a user to be printed on a product blank. The method may include a step of providing a processor, and a memory in communication with the processor. The memory may include a communication module, an apportionment module, a path recording module, a shading overlay module, and a GUI module. The communication module may receive the image to be printed on the product blank and an identified parameter of the image for the product blank. The apportionment module may determine a die-line file and an image file to be printed on the product blank. The die-line file may include a die-line perimeter and a die-line file surface area. The image file may include an image file perimeter and an image file surface area. The GUI module may display a preview of the die-line file and the image file, in real-time. The GUI module may display a superimposition of the image file surface area on the die-line file surface area such that the image file perimeter is bounded entirely by the die-line perimeter. The GUI module may include a cursor that may allow the user to establish an anchored endpoint adjacent to a crop boundary of the image. The cursor may allow the user to manually move a movable endpoint around the crop boundary. The path recording module may record a path of the movable endpoint corresponding to a tracing by the user of the crop boundary. The path may include a line segment extending from the anchored endpoint to the movable endpoint. The shading overlay module may overlay a shading on the image in real time as the user moves the movable endpoint along the path. The method may include a step of establishing an anchored endpoint adjacent to a crop boundary of the image via the cursor. The method may include a step of permitting the user to manually move the movable endpoint via the cursor around the crop boundary of the image. The method may include a step of generating a line segment between the anchored endpoint and the movable endpoint. The method may include a step of recording a path of the movable endpoint. The path may correspond to a tracing by the user of the crop boundary of the image. The method may include a step of determining an area between the line segment and the path in real time as the user moves the movable endpoint. The method may include a step of overlaying a shading on the area as the user moves the movable endpoint along the path. The method may include a step of displaying an entirety of the area overlayed with the shading when the movable endpoint converges with the anchored endpoint. The method may include a step of generating the image file and the die-line file based on the area overlayed with shading. The method may include a step of producing a customized printed product based on the image file and the die-line file.

In certain embodiments, the method may include a step of providing a memory that includes a border generation module. The border generation module may generate a border extending outwardly from the image file perimeter by a predetermined distance. The border may include the area between an image file perimeter and the die-line perimeter. The method may include a step of generating a border extending outwardly from the image file perimeter. The method may include a step of providing a geometric element displayable on the GUI module. The method may include a step of centering the movable endpoint within the geometric element. The method may include a step of moving the geometric element via the cursor. displaying visual feedback via the shading overlay module, the visual feedback including color changes in the shading when the movable endpoint is positioned over a feature within the image. The method may include a step of providing a geometric element displayable on the GUI module. The method may include a step of centering the movable endpoint within the geometric element. The method may include a step of moving the geometric element via the cursor. The method may include a step of displaying visual feedback via the shading overlay module, the visual feedback including color changes in the shading when the movable endpoint is positioned over a feature within the image. The method may include a step of altering a tracing of the crop boundary via the path recording module.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1. Illustrates an example for creating a custom printed product using automatic cropping and manual cropping options;

FIGS. 2-4 illustrate progressive stages in an example of creating a custom printed product using the manual cropping option in creating a custom printed product, as shown in FIG. 1;

FIG. 5 illustrates various ways of creating a border on a custom printed product using the manual cropping option in creating a custom printed product, as shown in FIG. 1;

FIGS. 6A and 6B are block diagrams each illustrating an embodiment of a system for creating a custom printed product;

FIGS. 7A and 7B provide a flowchart illustrating an embodiment of a method for cropping an image to be used on a product blank;

FIG. 8 provides a flowchart illustrating an embodiment of a method for cropping an image to be used on a product blank;

FIG. 9 provides a flowchart illustrating an embodiment of a method for cropping an image to be used on a product blank;

FIG. 10 provides a flowchart illustrating an embodiment of a method for cropping an image to be used on a product blank; and

FIG. 11 provides a flowchart illustrating an embodiment of a method for cropping an image to be used on a product blank.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of a steps presented is exemplary in nature, and thus, the order of a steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

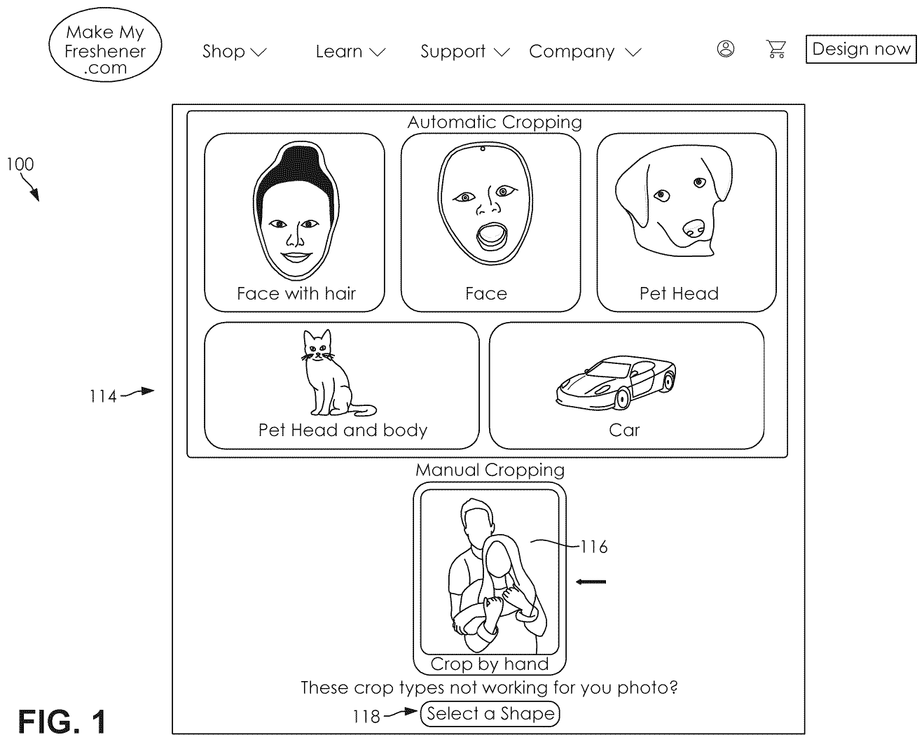

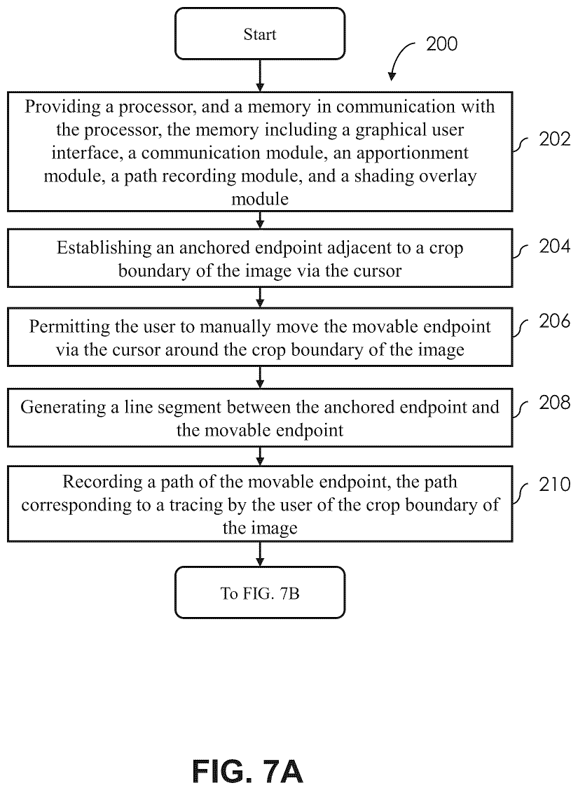

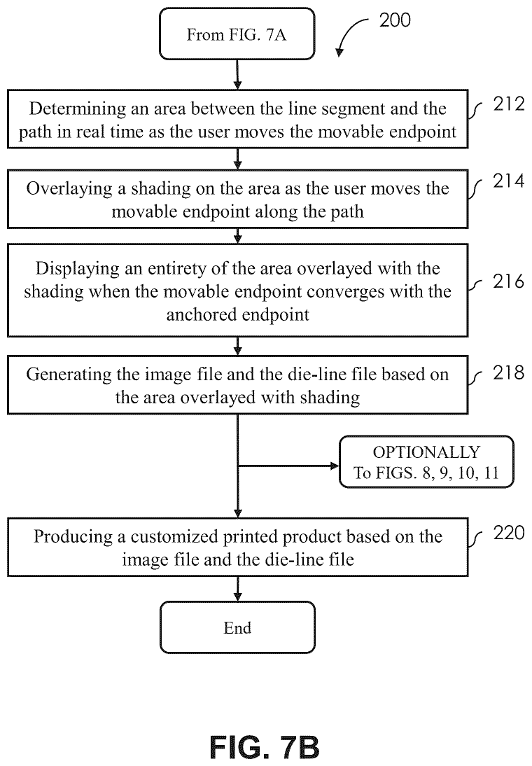

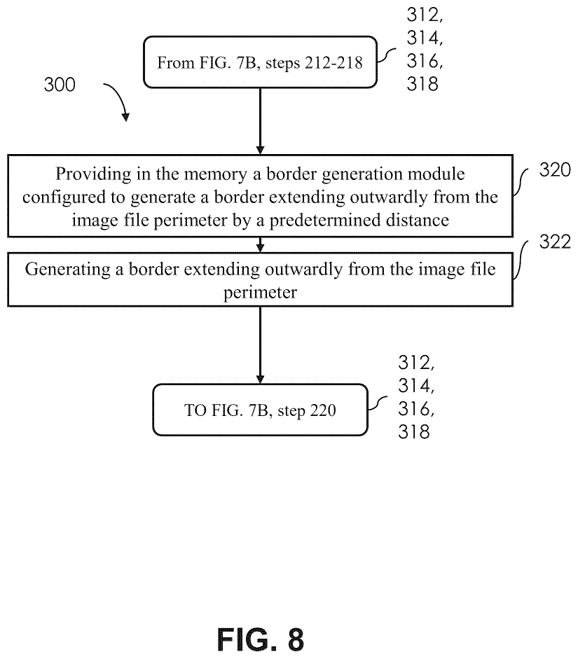

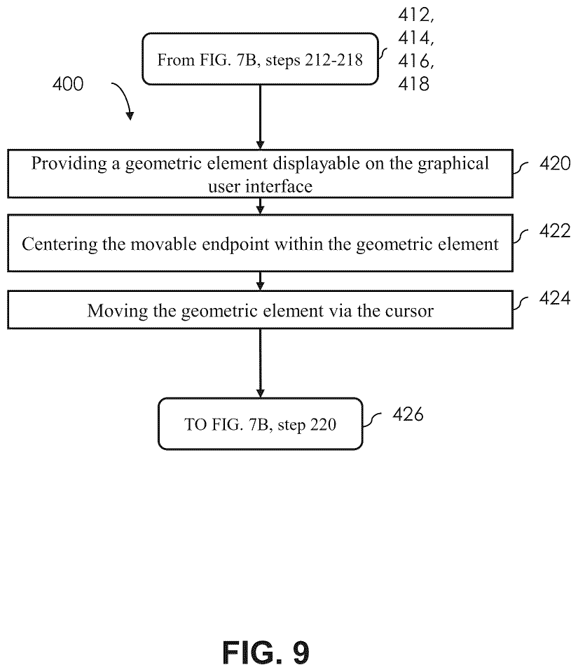

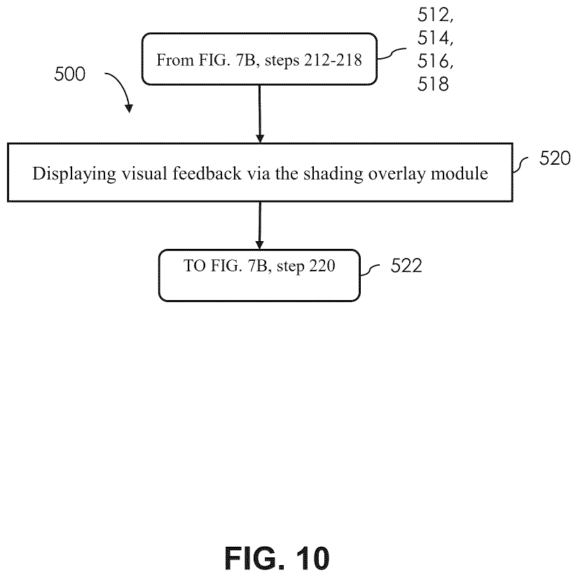

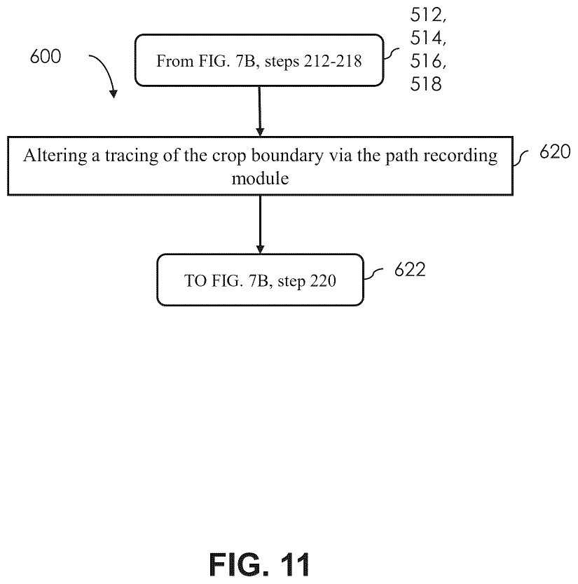

The present technology provides an advanced system 100 for manually cropping images that are to be printed on various products, incorporating manually guided cropping and machine learning algorithms to streamline the design-to-production workflow, aspects of which are shown generally in accompanying FIGS. 1-6B. A method 200 for manually cropping images that are to be printed on various products is also disclosed, aspects of which are shown in FIGS. 7A-7B. Another method 300 for manually cropping images that are to be printed on various products is disclosed, aspects of which are shown in FIG. 8. Another method 400 for manually cropping images that are to be printed on various products is also disclosed, aspects of which are shown in FIG. 9. Another method 500 for manually cropping images that are to be printed on various products is also disclosed, aspects of which are shown in FIG. 10. And another method 600 for manually cropping images that are to be printed on various products is also disclosed, aspects of which are shown in FIG. 11.

The system 100 and methods 200, 300, 400, 500, 600 allow a user 104 to upload an image 102 with a manual cropping option 116 through a graphical user interface (GUI module) module114 and manually crop an image 102 with a cursor 158. The user 104 establishes an anchored endpoint 140 with the cursor 158 adjacent to a crop boundary 144 of the image 102. In other words, the user 104 decides where the crop boundary 144 of the image 102 will start by placing the cursor 158 over the crop boundary 144 and subsequently tracing 108 the crop boundary 144 with a movable endpoint 142. The user 104 may manually move a movable endpoint 142 around the crop boundary 144 with the cursor 158. The system 100 displays a line segment 146 in real time extending from the anchored endpoint 140 to the movable endpoint 142 and overlays a shading 150 on the image 102 in real time as the user 104 moves the movable endpoint 142 along a path 138 to indicate the area of the image 102 to be cropped and printed on the product blank 106. Once the user 104 has traced 108 the entire crop boundary 144 of the image 102, the GUI module 114 may allow the user 104 to print the cropped image 102 on the product blank 106 to create a custom printed product.

As shown in FIGS. 1-6B, a system 100 is provided for cropping an image 102 by a user 104, where the image 102 to be printed on a product blank 106. The system 100 may include a processor 110 and may include a memory 112, where the memory 112 may be in communication with the processor 110. The memory 112 may include a GUI module 114 that may include a manual cropping option 116. The memory 112 may include a communication module 118 that may receive the image 102 to be printed on the product blank 106 and an identified parameter 120 of the image 102 for the product blank 106. The memory 112 may include an apportionment module 122 that may determine a die-line file 124 and an image file 126 to be printed on the product blank 106. The die-line file 124 may include a die-line perimeter 128 and a die-line file surface area 130. The image file 126 may include an image file perimeter 132 and an image file surface area 134. The memory 112 may include a path recording module 136 that may record a path 138 starting with an anchored endpoint 140 following a movable endpoint 142 corresponding to a tracing 108 by the user 104 of the crop boundary 144. The path 138 may include a line segment 146 extending from the anchored endpoint 140 to the movable endpoint 142. The memory 112 may include a shading overlay module 148 that may overlay a shading 150 on the image 102 in real time as the user 104 moves the movable endpoint 142 along the path 138. The memory 112 may include an artificial intelligence module 152 that may center a geometric element 154 on the crop boundary 144.

The processor 110 may include the following aspects. The processor 110 may be located on a system server 156. For example, the system server 156 may be a local server or remote server. The system server 156 may be the central hub of the system 100, containing the processor 110 and memory 112 that store and execute the modules necessary for the cropping process. The system server 156 may handle the complex computations and data management required for cropping the image 102. One skilled in the art will also appreciate that the processor 110 may include one or more processors 110 and may process information and executing instructions or operations. The processor 110 can be any type of general or specific purpose processor 110. For example, the processor 110 may include a central processing unit (CPU), a microprocessor, a microcontroller, or a system-on-a-chip, a digital signal processor (DSPs), field-programmable gate arrays (FPGAs), application-specific integrated circuits (ASICs), or processors based on a multi-core processor architecture. One or more processors 110 may mean a single processor 110 or multiple processors 110 in a single processing unit (e.g., a central processing unit) or multiple processing units (e.g., a central processing unit and a graphics processing unit; or a central processing unit and a memory manager) and may include multiple processors 110 where one processor 110 is capable of executing one or more of the elements described in this disclosure, and a subsequent processor 110 or processors may execute other elements as described herein, capable of executing all elements only in combination. One or more of the processors 110 may be remote from the at least one system server 156.

The memory 112 may include the following aspects. The memory 112 may store or otherwise include a plurality of databases. The memory 112 can be one or more memories 112 and of any type suitable to the local application environment and can be implemented using any suitable volatile or nonvolatile data storage technology such as a semiconductor-based memory device, a magnetic memory device and system, an optical memory device and system, fixed memory 112, and removable memory 112. For example, the memory 112 can consist of any combination of random-access memory (RAM), read only memory (ROM), static storage such as a magnetic or optical disk, hard disk drive (HDD), or any other type of non-transitory machine or computer readable media.

The GUI module 114 may include the following aspects. The GUI module 114 may serve as an interface for the system 100. The GUI module 114 may serve as the point of interaction between a user and the system 100 and interact with hardware including various output devices that may display a representation of the GUI module for observation by the user, where such output devices may include one or more computer screens, speakers, tablet screens, or other view/audio ports, input devices such as keyboards, microphones, and the like. For example, the GUI module 114 may be accessible via a webpage, a desktop application, or smartphone application. The GUI module 114 may allow the user 104 to select the manual cropping option 116 to manually crop an image 102. Once a user 104 uploads an image 102, the GUI module 114 may display a preview of the die-line file 124 and the image file 126 in real-time for the user 104. Specifically, the GUI module 114 may display a superimposition of the image file surface area 134 on the die-line file surface area 130 such that the image file perimeter 132 is bounded entirely by the die-line perimeter 128. The GUI module 114 may include a cursor 158. The GUI module 114 may include a geometric element 154 displayable on the GUI module 114. The geometric element 154 may be movable using the cursor 158. The movable endpoint 142 may be automatically positioned within the geometric element 154. Alternatively, the geometric element 154 may be manually centered over the crop boundary 144 by the user 104 using the cursor 158. It should be appreciated that the GUI module 114 may deliver immediate feedback, offering the user 104 the necessary guidance to achieve the desired crop boundary 144 in alignment with product specifications. The GUI module 114 may be designed to be intuitive and user-friendly, allowing the user 104 to easily interact with the system 100 and visualize their design changes.

The cursor 158 may include the following aspects. The cursor 158 may allow the user 104 to establish an anchored endpoint 140 adjacent to a crop boundary 144 of the image 102. The cursor 158 may allow the user 104 to manually move a movable endpoint 142 around the crop boundary 144. For example, the cursor 158 may allow the user 104 interactive control over the cropping process by establishing an anchored endpoint 140 at a fixed starting point of the crop boundary 144 and manually move a movable endpoint 142 around the crop boundary 144, facilitating detailed customization of the crop boundary 144. The cursor 158 may interact with pointing device 164 such as a mouse 166, a stylus 168, or a touch-sensitive screen 170, depending on the preference of the user 104 and the configuration of the system 100. The cursor 158 may allow the user 104 to move the geometric element 154 to center the movable endpoint 142 with the crop boundary 144 and to move the geometric element 154 along the crop boundary 144.

The geometric element 154 may include the following aspects. The geometric element 154 may be displayed on the GUI module 114, with the movable endpoint 142 typically centered within this element. The geometric element 154 may include a shape that has a transparent center in order for a user 104 to see the crop boundary 144 underneath. The geometric element 154 may be adjusted manually by the user 104. Alternatively, the geometric element 154 may be automatically centered using an artificial intelligence module 152, assisting the user 104 in aligning the geometric element 154 to the crop boundary 144. The geometric element 154 may be relocated via the cursor 158 at any point in the cropping process, providing an intuitive guide for the user 104 to produce a precisely cropped image 102. It should be appreciated that the geometric element 154 aids the user 104 in visualizing the crop boundary 144 due to the transparent center of the geometric element 154, providing a reference point for the movable endpoint 142.

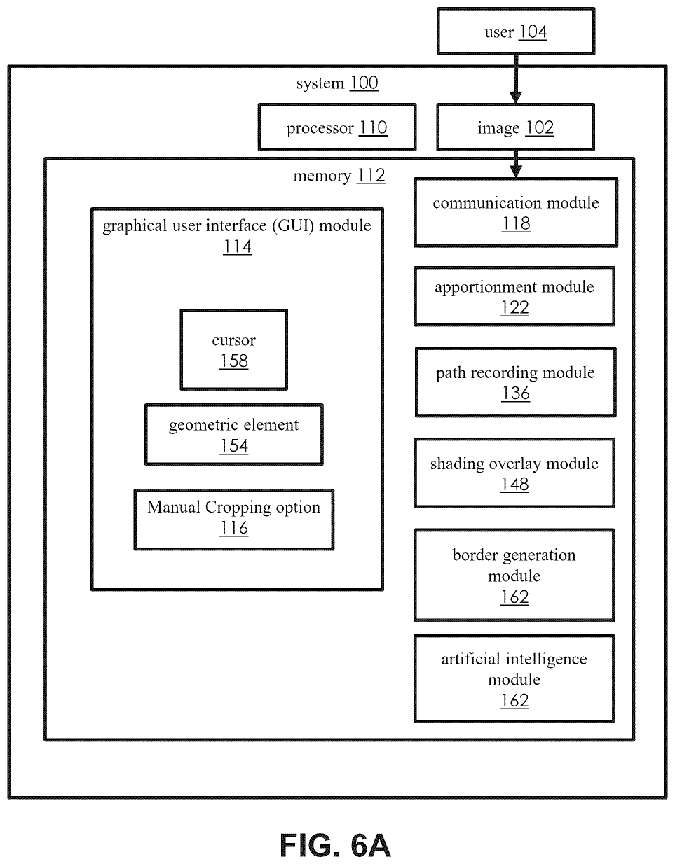

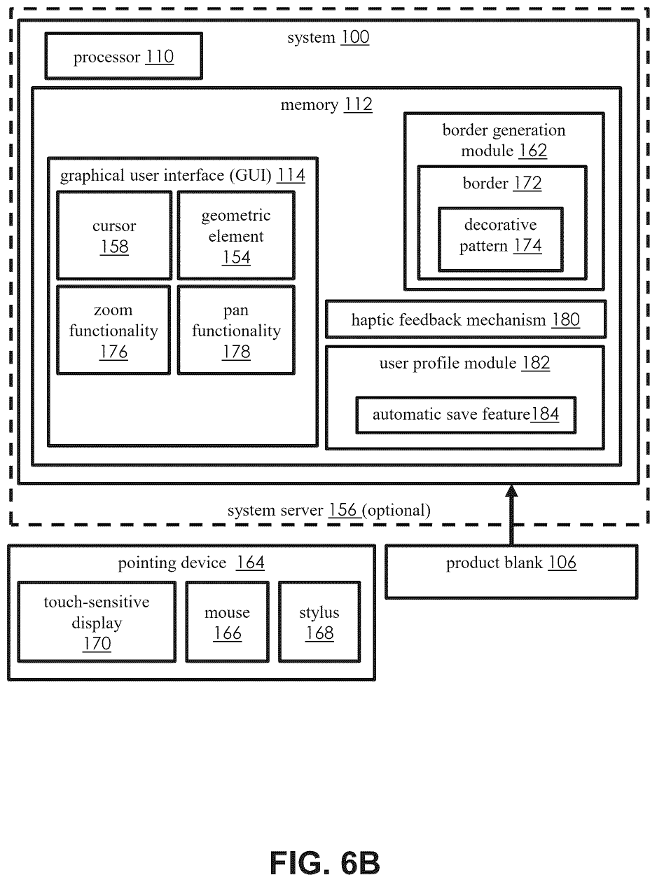

Referring now to FIGS. 6A and 6B, the communication module 118 may include the following aspects. The communication module 118 may allow the user 104 to upload an image 102 to the system 100, facilitating the input of a pre-cropped image 102 and output of a cropped image 102. Specifically, the communication module 118 may be responsible for receiving the image 102 and the identified parameter 120 for the product blank 106. For example, the communication module 118 may ensure that all necessary data is gathered before the cropping of the image 102 commences. As shown in FIG. 1, the communication module 118 may also allow the user 104 to select the shape of the image file perimeter 132.

The apportionment module 122 may include the following aspects. The apportionment module 122 may generate the die-line file 124 and image file 126. The die-line file 124 may specify the perimeter and surface area of a product outline, while the image file 126 may detail similar parameters for the image 102 itself. The apportionment module 122 may assist in defining which sections of the image 102 will be adjusted to conform with the dimensions of the product blank 106, aiding in the precise execution of the cropping process. Once the user 104 has finished tracing 108 the image 102, the apportionment module 122 may process the crop boundary 144 defined by the user 104 and generate the files necessary for creating the customized printed product.

The path recording module 136 may include the following aspects. The path recording module 136 may capture the trajectory of the movable endpoint 142 as defined by user 104 interactions. The path recording module 136 may record a path 138 including the line segment 146 that extends between the anchored endpoint 140 and the movable endpoint 142. This path 138 may form the crop boundary 144, ensuring accuracy throughout the process of cropping the image 102. For example, the path recording module 136 may record the path 138 of the movable endpoint 142, capturing the crop boundary 144 defined by the user 104, or alternatively, capturing the crop boundary 144 established with assistance from the artificial intelligence module 152. The line segment 146 between the anchored and the movable endpoint 142 may be displayed as a distinct color or width for accurately delineating the crop region. It should be appreciated that the path recording module 136 may ensure that the manual tracing 108 by the user 104 is accurately captured and can be used to generate the final cropped image 102. The path recording module 136 may also allow the user 104 to alter 160 the tracing 108 by the user 104 of the crop boundary 144, enhancing the accuracy of the path 138 and militating against unnecessary errors.

The shading overlay module 148 may include the following aspects. The shading overlay module 148 may enhance the precision of the user 104 by providing real-time visual cues in the form of shading 150, which may follow the path 138 of the movable endpoint 142. The shading overlay module 148 may dynamically highlight selected areas, aiding the user 104 in fine-tuning the cropping process. For example, the shading overlay module 148 may superimpose shading 150 on the image file surface area 134 in real-time, corresponding to the cursor 158 movements by the user 104. It should be appreciated that visual cues such as shading 150 may facilitate precision in cropping by highlighting the areas of the image 102 that will be used on a product after cropping. The shading overlay module 148 may overlay a translucent shading 150 on the image 102 to provide visual feedback during the cropping process without completely obscuring the image 102 features. Alternatively, the shading overlay module 148 may overlay an opaque shading 150 to enhance the ability of the user 104 to see the impact of their cropping decisions on the final product, including overall shape and proportions.

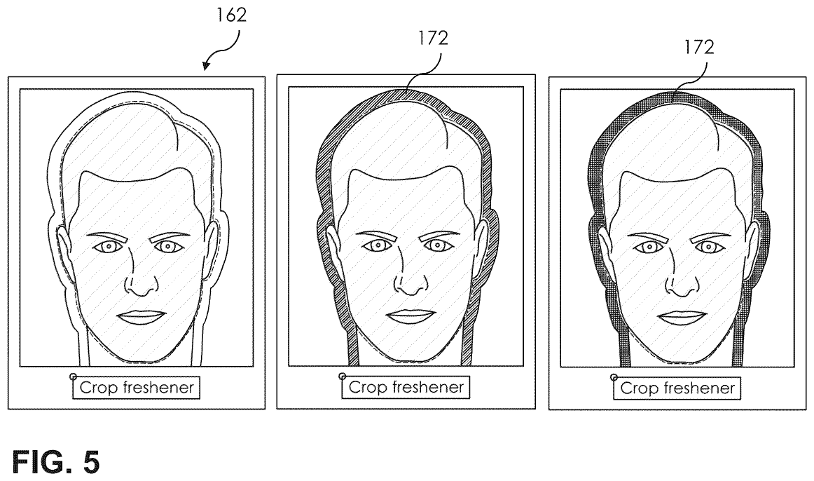

As shown in FIG. 6A, the memory 112 may also include a border generation module 162. The border generation module 162 may create a border 172 extending outwardly from the cropped image 102 by a predetermined distance, as shown in FIG. 5. The border generation module 162 may be responsible for defining the final appearance of the border 172 around the cropped image 102, contributing to the overall aesthetic of the product. The border 172 may include an area between the image file perimeter 132 and the die-line perimeter 128. The border generation module 162 may generate a plurality of borders 172 of predetermined widths. The border generation module 162 may allow the user 104 to alter 160 the border 172 in real-time. The border generation module 162 may incorporate a decorative pattern 174 within the area between the image file perimeter 132 and the die-line perimeter 128. For example, the border generation module 162 may allow for the creation and customization of graphic borders 172 extending outward from the image file perimeter 132. The user 104 may also adjust border 172 aesthetics to personalize the final product.

The system 100 may also include various features designed to further enhance user 104 interaction, including a zoom functionality 176 and a pan functionality 178 on the GUI module 114, a haptic feedback mechanism 180, and a user profile module 182. The zoom functionality 176 and pan functionality 178 may interact with a touch-sensitive screen 170, mouse 166, or stylus 168. The zoom functionality 176 and a pan functionality 178 may permit the user 104 to view the image 102 from various perspectives, thereby improving control during the cropping process. The system 100 may include a haptic feedback mechanism 180. The haptic feedback mechanism 180 may provide a physical sensation to the user 104 when the movable endpoint 142 is positioned over a feature within the image 102. For example, the haptic feedback mechanism 180 may provide tactile cues when the cursor 158 interacts with the image 102 features, enhancing user 104 engagement during the cropping process. The user profile module 182 may include an automatic save feature 184 in order to save an image 102, decorative patterns within the border 172 area, and other preferences of the user 104. For example, the automatic save feature 184 may help in preserving user 104 progress, where the user profile module 182 retains preferences and historical cropping patterns. It should be appreciated that the automatic save feature 184 may ensure a consistent user 104 experience across multiple sessions.

As shown in FIGS. 7A and 7B, a method 200 is provided for cropping an image 102 by a user 104 to be printed on a product blank 106. The method 200 may include a step 202 of providing a processor 110, and a memory 112 in communication with the processor 110, the memory 112 including a communication module 118, an apportionment module 122, a path recording module 136, a shading overlay module 148, and a GUI module 114. The communication may receive the image 102 to be printed on the product blank 106 and an identified parameter 120 of the image 102 for the product blank 106. The apportionment module 122 may determine a die-line file 124 and an image file 126 to be printed on the product blank 106. The die-line file 124 may include a die-line perimeter 128 and a die-line file surface area 130. The image file 126 may include an image file perimeter 132 and an image file surface area 134. The GUI module 114 may display a preview of the die-line file 124 and the image file 126, in real-time. The GUI module 114 may display a superimposition of the image file surface area 134 on the die-line file surface area 130 such that the image file perimeter 132 is bounded entirely by the die-line perimeter 128. The GUI module 114 may include a cursor 158. The cursor 158 may allow the user 104 to establish an anchored endpoint 140 adjacent to a crop boundary 144 of the image 102. The cursor 158 may allow the user 104 to manually move a movable endpoint 142 around the crop boundary 144. The path recording module 136 may record a path 138 of the movable endpoint 142 corresponding to a tracing 108 by the user 104 of the crop boundary 144. The path 138 may include a line segment 146 extending from the anchored endpoint 140 to the movable endpoint 142. The shading overlay module 148 may overlay a shading 150 on the image 102 in real time as the user 104 moves the movable endpoint 142 along the path 138. The method 200 may include a step 204 of establishing an anchored endpoint 140 adjacent to a crop boundary 144 of the image 102 via the cursor 158. The method 200 may include a step 206 of permitting the user 104 to manually move the movable endpoint 142 via the cursor 158 around the crop boundary 144 of the image 102. The method 200 may include a step 208 of generating a line segment 146 between the anchored endpoint 140 and the movable endpoint 142. The method 200 may include a step 210 of recording a path 138 of the movable endpoint 142. The path 138 may correspond to a tracing 108 by the user 104 of the crop boundary 144 of the image 102. The method 200 may include a step 212 of determining an area between the line segment 146 and the path 138 in real time as the user 104 moves the movable endpoint 142. The method 200 may include a step 214 of overlaying a shading 150 on the area as the user 104 moves the movable endpoint 142 along the path 138. The method 200 may include a step 216 of displaying an entirety of the area overlayed with the shading 150 when the movable endpoint 142 converges with the anchored endpoint 140. The method 200 may include a step 218 of generating the image file 126 and the die-line file 124 based on the area overlayed with shading 150. The method 200 may include a step 220 of producing a customized printed product based on the image file 126 and the die-line file 124.

As shown in FIG. 8, a method 300 is provided for cropping an image 102 by a user 104 to be printed on a product blank 106. The method 300 may include a step 302 of providing a processor 110, and a memory 112 in communication with the processor 110, the memory 112 including a communication module 118, an apportionment module 122, a path recording module 136, a shading overlay module 148, and a GUI module 114. The communication may receive the image 102 to be printed on the product blank 106 and an identified parameter 120 of the image 102 for the product blank 106. The apportionment module 122 may determine a die-line file 124 and an image file 126 to be printed on the product blank 106. The die-line file 124 may include a die-line perimeter 128 and a die-line file surface area 130. The image file 126 may include an image file perimeter 132 and an image file surface area 134. The GUI module 114 may display a preview of the die-line file 124 and the image file 126, in real-time. The GUI module 114 may display a superimposition of the image file surface area 134 on the die-line file surface area 130 such that the image file perimeter 132 is bounded entirely by the die-line perimeter 128. The GUI module 114 may include a cursor 158. The cursor 158 may allow the user 104 to establish an anchored endpoint 140 adjacent to a crop boundary 144 of the image 102. The cursor 158 may allow the user 104 to manually move a movable endpoint 142 around the crop boundary 144. The path recording module 136 may record a path 138 of the movable endpoint 142 corresponding to a tracing 108 by the user 104 of the crop boundary 144. The path 138 may include a line segment 146 extending from the anchored endpoint 140 to the movable endpoint 142. The shading overlay module 148 may overlay a shading 150 on the image 102 in real time as the user 104 moves the movable endpoint 142 along the path 138. The method 300 may include a step 304 of establishing an anchored endpoint 140 adjacent to a crop boundary 144 of the image 102 via the cursor 158. The method 300 may include a step 306 of permitting the user 104 to manually move the movable endpoint 142 via the cursor 158 around the crop boundary 144 of the image 102. The method 300 may include a step 308 of generating a line segment 146 between the anchored endpoint 140 and the movable endpoint 142. The method 300 may include a step 310 of recording a path 138 of the movable endpoint 142. The path 138 may correspond to a tracing 108 by the user 104 of the crop boundary 144 of the image 102. The method 300 may include a step 312 of determining an area between the line segment 146 and the path 138 in real time as the user 104 moves the movable endpoint 142. The method 300 may include a step 314 of overlaying a shading 150 on the area as the user 104 moves the movable endpoint 142 along the path 138. The method 300 may include a step 316 of displaying an entirety of the area overlayed with the shading 150 when the movable endpoint 142 converges with the anchored endpoint 140. The method 300 may include a step 318 of generating the image file 126 and the die-line file 124 based on the area overlayed with shading 150. The method 300 may include a step 320 of providing in the memory a border generation module 162 configured to generate a border 172 extending outwardly from the image file perimeter 132 by a predetermined distance. The border 172 may include the area between an image file perimeter 132 and the die-line perimeter 128. The method 300 may include a step 322 of generating a border 172 extending outwardly from the image file perimeter 132. The method 300 may include a step 324 of producing a customized printed product based on the image file 126 and the die-line file 124.

As shown in FIG. 9, a method 400 is provided for cropping an image 102 by a user 104 to be printed on a product blank 106. The method 400 may include a step 402 of providing a processor 110, and a memory 112 in communication with the processor 110, the memory 112 including a communication module 118, an apportionment module 122, a path recording module 136, a shading overlay module 148, and a GUI module 114. The communication may receive the image 102 to be printed on the product blank 106 and an identified parameter 120 of the image 102 for the product blank 106. The apportionment module 122 may determine a die-line file 124 and an image file 126 to be printed on the product blank 106. The die-line file 124 may include a die-line perimeter 128 and a die-line file surface area 130. The image file 126 may include an image file perimeter 132 and an image file surface area 134. The GUI module 114 may display a preview of the die-line file 124 and the image file 126, in real-time. The GUI module 114 may display a superimposition of the image file surface area 134 on the die-line file surface area 130 such that the image file perimeter 132 is bounded entirely by the die-line perimeter 128. The GUI module 114 may include a cursor 158. The cursor 158 may allow the user 104 to establish an anchored endpoint 140 adjacent to a crop boundary 144 of the image 102. The cursor 158 may allow the user 104 to manually move a movable endpoint 142 around the crop boundary 144. The path recording module 136 may record a path 138 of the movable endpoint 142 corresponding to a tracing 108 by the user 104 of the crop boundary 144. The path 138 may include a line segment 146 extending from the anchored endpoint 140 to the movable endpoint 142. The shading overlay module 148 may overlay a shading 150 on the image 102 in real time as the user 104 moves the movable endpoint 142 along the path 138. The method 400 may include a step 404 of establishing an anchored endpoint 140 adjacent to a crop boundary 144 of the image 102 via the cursor 158. The method 400 may include a step 406 of permitting the user 104 to manually move the movable endpoint 142 via the cursor 158 around the crop boundary 144 of the image 102. The method 400 may include a step 408 of generating a line segment 146 between the anchored endpoint 140 and the movable endpoint 142. The method 400 may include a step 410 of recording a path 138 of the movable endpoint 142. The path 138 may correspond to a tracing 108 by the user 104 of the crop boundary 144 of the image 102. The method 400 may include a step 412 of determining an area between the line segment 146 and the path 138 in real time as the user 104 moves the movable endpoint 142. The method 400 may include a step 414 of overlaying a shading 150 on the area as the user 104 moves the movable endpoint 142 along the path 138. The method 400 may include a step 416 of displaying an entirety of the area overlayed with the shading 150 when the movable endpoint 142 converges with the anchored endpoint 140. The method 400 may include a step 418 of generating the image file 126 and the die-line file 124 based on the area overlayed with shading 150. The method 400 may include a step 420 of providing a geometric element 154 displayable on the GUI module 114. The method 400 may include a step 422 of centering the movable endpoint 142 within the geometric element 154. The method 400 may include a step 424 of moving the geometric element 154 via the cursor158. The method 400 may include a step 426 of producing a customized printed product based on the image file 126 and the die-line file 124.

As shown in FIG. 10, a method 500 is provided for cropping an image 102 by a user 104 to be printed on a product blank 106. The method 500 may include a step 502 of providing a processor 110, and a memory 112 in communication with the processor 110, the memory 112 including a communication module 118, an apportionment module 122, a path recording module 136, a shading overlay module 148, and a GUI module 114. The communication may receive the image 102 to be printed on the product blank 106 and an identified parameter 120 of the image 102 for the product blank 106. The apportionment module 122 may determine a die-line file 124 and an image file 126 to be printed on the product blank 106. The die-line file 124 may include a die-line perimeter 128 and a die-line file surface area 130. The image file 126 may include an image file perimeter 132 and an image file surface area 134. The GUI module 114 may display a preview of the die-line file 124 and the image file 126, in real-time. The GUI module 114 may display a superimposition of the image file surface area 134 on the die-line file surface area 130 such that the image file perimeter 132 is bounded entirely by the die-line perimeter 128. The GUI module 114 may include a cursor 158. The cursor 158 may allow the user 104 to establish an anchored endpoint 140 adjacent to a crop boundary 144 of the image 102. The cursor 158 may allow the user 104 to manually move a movable endpoint 142 around the crop boundary 144. The path recording module 136 may record a path 138 of the movable endpoint 142 corresponding to a tracing 108 by the user 104 of the crop boundary 144. The path 138 may include a line segment 146 extending from the anchored endpoint 140 to the movable endpoint 142. The shading overlay module 148 may overlay a shading 150 on the image 102 in real time as the user 104 moves the movable endpoint 142 along the path 138. The method 500 may include a step 504 of establishing an anchored endpoint 140 adjacent to a crop boundary 144 of the image 102 via the cursor 158. The method 500 may include a step 506 of permitting the user 104 to manually move the movable endpoint 142 via the cursor 158 around the crop boundary 144 of the image 102. The method 500 may include a step 508 of generating a line segment 146 between the anchored endpoint 140 and the movable endpoint 142. The method 500 may include a step 510 of recording a path 138 of the movable endpoint 142. The path 138 may correspond to a tracing 108 by the user 104 of the crop boundary 144 of the image 102. The method 500 may include a step 512 of determining an area between the line segment 146 and the path 138 in real time as the user 104 moves the movable endpoint 142. The method 500 may include a step 514 of overlaying a shading 150 on the area as the user 104 moves the movable endpoint 142 along the path 138. The method 500 may include a step 516 of displaying an entirety of the area overlayed with the shading 150 when the movable endpoint 142 converges with the anchored endpoint 140. The method 500 may include a step 518 of generating the image file 126 and the die-line file 124 based on the area overlayed with shading 150. The method 500 may include a step 520 of displaying visual feedback via the shading overlay module 148. For example, the visual feedback may include color changes in the shading 150 when the movable endpoint 142 is positioned over a feature within the image 102. The method 500 may include a step 522 of producing a customized printed product based on the image file 126 and the die-line file 124.

As shown in FIG. 11, a method 600 is provided for cropping an image 102 by a user 104 to be printed on a product blank 106. The method 600 may include a step 602 of providing a processor 110, and a memory 112 in communication with the processor 110, the memory 112 including a communication module 118, an apportionment module 122, a path recording module 136, a shading overlay module 148, and a GUI module 114. The communication may receive the image 102 to be printed on the product blank 106 and an identified parameter 120 of the image 102 for the product blank 106. The apportionment module 122 may determine a die-line file 124 and an image file 126 to be printed on the product blank 106. The die-line file 124 may include a die-line perimeter 128 and a die-line file surface area 130. The image file 126 may include an image file perimeter 132 and an image file surface area 134. The GUI module 114 may display a preview of the die-line file 124 and the image file 126, in real-time. The GUI module 114 may display a superimposition of the image file surface area 134 on the die-line file surface area 130 such that the image file perimeter 132 is bounded entirely by the die-line perimeter 128. The GUI module 114 may include a cursor 158. The cursor 158 may allow the user 104 to establish an anchored endpoint 140 adjacent to a crop boundary 144 of the image 102. The cursor 158 may allow the user 104 to manually move a movable endpoint 142 around the crop boundary 144. The path recording module 136 may record a path 138 of the movable endpoint 142 corresponding to a tracing 108 by the user 104 of the crop boundary 144. The path 138 may include a line segment 146 extending from the anchored endpoint 140 to the movable endpoint 142. The shading overlay module 148 may overlay a shading 150 on the image 102 in real time as the user 104 moves the movable endpoint 142 along the path 138. The method 600 may include a step 604 of establishing an anchored endpoint 140 adjacent to a crop boundary 144 of the image 102 via the cursor 158. The method 600 may include a step 606 of permitting the user 104 to manually move the movable endpoint 142 via the cursor 158 around the crop boundary 144 of the image 102. The method 600 may include a step 608 of generating a line segment 146 between the anchored endpoint 140 and the movable endpoint 142. The method 600 may include a step 610 of recording a path 138 of the movable endpoint 142. The path 138 may correspond to a tracing 108 by the user 104 of the crop boundary 144 of the image 102. The method 600 may include a step 612 of determining an area between the line segment 146 and the path 138 in real time as the user 104 moves the movable endpoint 142. The method 600 may include a step 614 of overlaying a shading 150 on the area as the user 104 moves the movable endpoint 142 along the path 138. The method 600 may include a step 616 of displaying an entirety of the area overlayed with the shading 150 when the movable endpoint 142 converges with the anchored endpoint 140. The method 600 may include a step 618 of generating the image file 126 and the die-line file 124 based on the area overlayed with shading 150. The method 600 may include a step 620 of altering 160 a tracing 108 of the crop boundary 144 via the path recording module 136. The method 600 may include a step 622 of producing a customized printed product based on the image file 126 and the die-line file 124.

Systems and methods of the present technology operate in conjunction with, may be integrated with, and may be combined with aspects described by Applicant's co-pending U.S. patent application Ser. No. 18/590,481, filed on Feb. 28, 2024, titled SYSTEM AND METHOD FOR CUSTOMIZED PRINTING, the entire disclosure of which is incorporated herein by reference.

Advantageously, the present technology provides a solution to the limitations of prior art by offering an improved system 100 and method for creating customized printed products. The system 100 addresses inefficiencies, increased production time, and potential misalignment issues inherent in conventional systems by integrating an artificial intelligence module 152. The system 100 allows for real-time processing of the image 102, automatic generation of a die-line file and an image file 126, and precise alignment between the printed image 102 and the cut shape. The present technology also enables the user 104 to visualize and modify the cropping of the image 102 with an intuitive GUI module 114, thereby militating against unnecessary errors, reducing manual labor, and enhancing the overall customization experience. As a result, the present technology significantly streamlines the cropping process, allowing for greater customization of printed products while ensuring high-quality outcomes and user 104 satisfaction.

### EXAMPLES

Example embodiments of the present technology are provided with reference to the several figures including FIGS. 1-11 enclosed herewith.

### Example 1: Custom Vehicle Air Freshener with Image of Pet

A user 104 desires to create a custom air freshener for their vehicle featuring a beloved pet. The user 104 accesses the system 100 via a GUI module 114 on their personal computer and uploads a high-resolution image 102 of their pet. The system 100 server, equipped with advanced image recognition capabilities, analyzes the image 102 and permits the user 104 to perform a manual cropping, with the assistance of artificial intelligence or machine learning algorithms, and can present the user 104 with several crop type options, including a full-body image 102 of the pet or just the face.

The user 104 manually crops an image 102 of the face of the pet for a more personalized touch. The apportionment module 122 then generates a die-line file 124 that outlines the face of the pet with precision, taking into account the unique contours and features. The user 104 is presented with a real-time preview of the die-line file and the image file 126, including a shading 150 that allows for visual confirmation of the crop area, and a line segment 146 that indicates the path 138 the user 104 has created along the crop boundary 144. The user 104 can make adjustments to the crop boundary 144 using the cursor 158, ensuring the final product will meet their expectations.

Once satisfied with the design, the user 104 finalizes the crop and selects a fragrance for the air freshener. The system 100 then proceeds to generate the final image file 126 and die-line file 124. The system 100 will then send the image file 126 and die-line file 124 for custom printing to create an air freshener with the exact shape of the face of the pet, resulting in a customized and sentimental product for the user 104 to display in their vehicle.

### Example 2: Personalized Self-Portrait Canvas Print

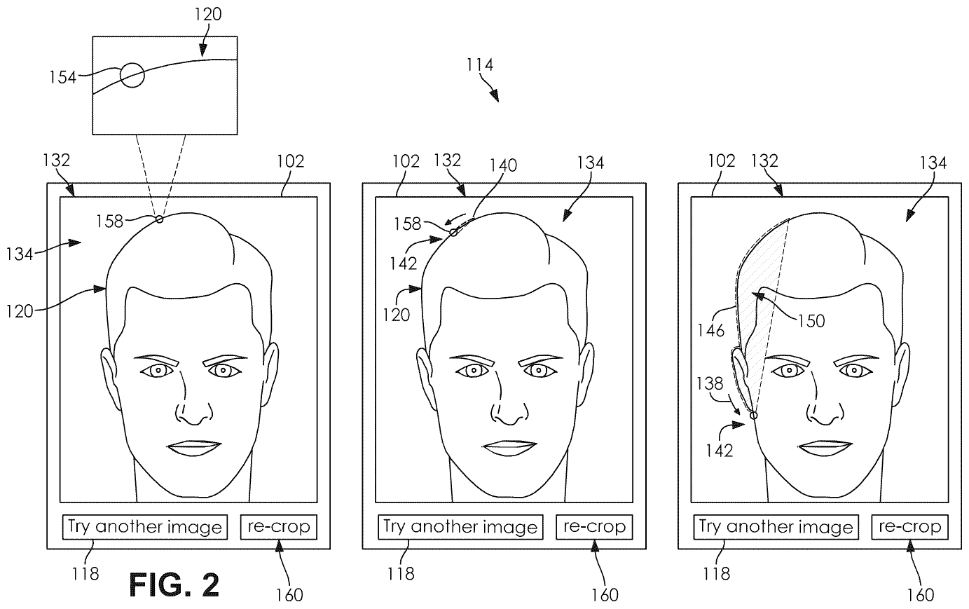

An art enthusiast wishes to print a personalized canvas print of self-portrait. The art enthusiast uploads a digital copy of the photo to the system 100 and specifies that they want to focus on face for a dramatic effect. The art enthusiast is permitted to provide input on manual cropping and the artificial intelligence module 152 analyzes the painting and assists the user 104 in the manual cropping to highlight different aspects of the self-portrait, illustrated in FIGS. 2-5.

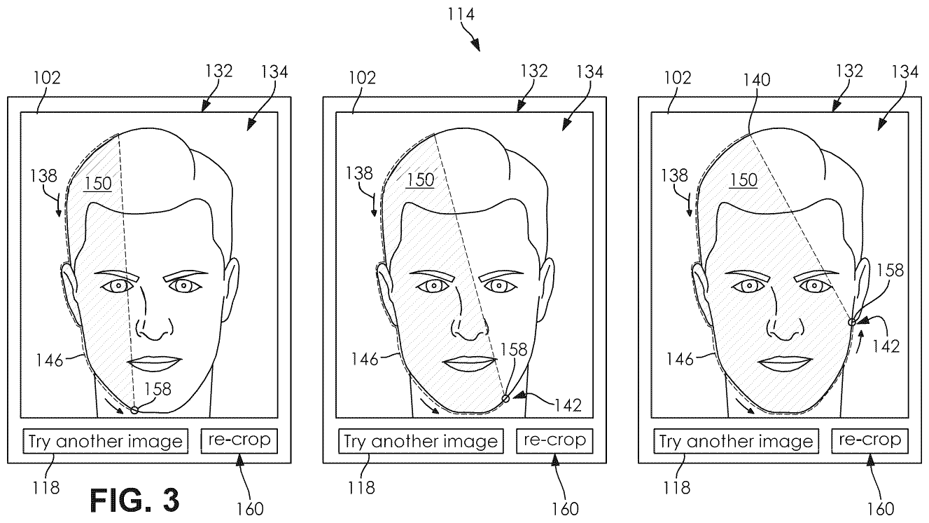

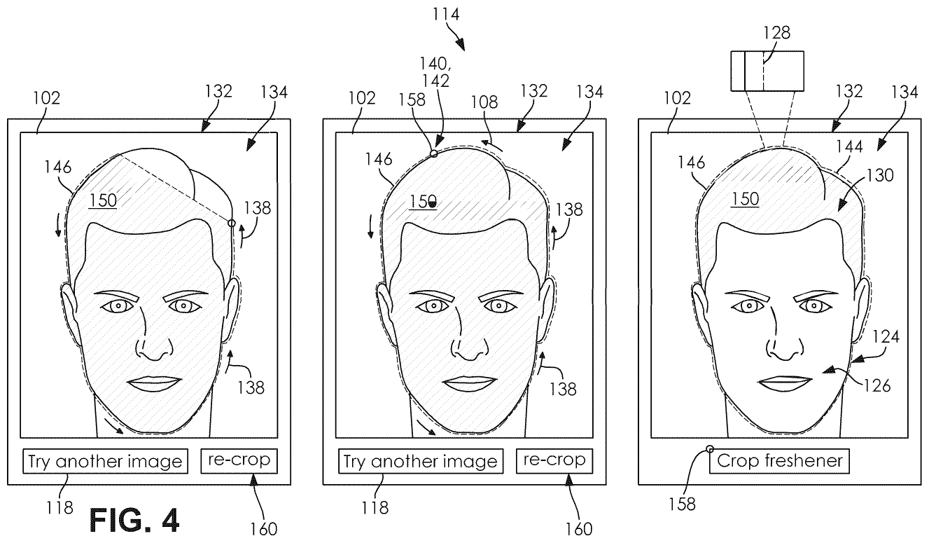

Now referring to FIG. 2, left photo, the art enthusiast may view the crop boundary 144 through a geometric element 154 using the cursor 158, allowing for precise placement of the anchored endpoint 140. In FIG. 2, middle photo and right photo, the art enthusiast chooses to manually crop the image 102 with the assistance of the artificial intelligence module 152. The art enthusiast creates a line segment 146 along the path 138 with the movable endpoint 142, where the shading overlay module 148 generates a shading 150 over the image file perimeter 132. In FIG. 3, the art enthusiast may move the cursor 158 counterclockwise along the crop boundary 144, where the shading 150 is overlayed within the line segment 146 in real-time. In FIG. 4, left photo and middle photo, the art enthusiast completes the cropping by merging the movable endpoint 142 with the anchored endpoint 140, forming a complete line segment 146 around the cropped image 102, where the shading 150 has fully enveloped the area within the crop boundary 144. When the art enthusiast makes an error, the system 100 allows the art enthusiast to alter 160 the path 138 of the movable endpoint 142 in order to accurately capture the crop boundary 144. In FIG. 4, right photo, the apportionment module 122 generates a die-line file 124 that respects the intricate details of the photo, ensuring that the final print will capture the essence of the original photo. In FIG. 5, the art enthusiast creates a border 172 with the border generation module 162 and adjusts the border 172 width to accommodate a custom frame they have in mind, utilizing the border generation module 162 to make informed decisions about the final appearance.

After approving the crop and border, the user 104 selects a high-quality canvas material for printing. The system 100 then creates the canvas print with a high degree of color accuracy and attention to detail. The final product is a personalized canvas print of the self-portrait that retains the artistic integrity of the original while adding a unique touch that reflects the personal taste of the art enthusiast.

### Example 3: Customized Die-Cut Stickers for a Small Business

A small business owner wants to create die-cut stickers featuring their company logo for a marketing campaign. The owner uploads the logo to the system 100 and uses the cursor 158 to manually define the crop boundary 144 around the logo, ensuring that the final stickers will have a custom shape that matches the aesthetic of the brand.

The artificial intelligence module 152 assists the owner by centering the geometric element 154 along the crop boundary 144 based on similar successful projects. The owner makes use of the alter 160 feature to fine-tune the crop path 138 using a stylus 168 that interacts with the cursor 158, and the translucent shading 150 overlay provides immediate visual feedback on the cropped area. The border generation module 162 adds a subtle border to the design, which will enhance the visual appeal of the sticker when applied to surfaces.

Once the design is finalized, the owner selects a durable vinyl material for the stickers and specifies the quantity needed. The system 100 efficiently prints and cuts the stickers, which feature the precise custom shape of the company logo. The stickers are then used in the marketing campaign, providing a professional and customized branding element that captures the attention of potential customers.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A system for cropping an image by a user, the image to be printed on a product blank, the system comprising:
a processor; and
a memory in communication with the processor, the memory including a graphical user interface (GUI) module, a communication module, an apportionment module, a path recording module, and a shading overlay module;
wherein:
the communication module is configured to receive the image to be printed on the product blank and an identified parameter of the image for the product blank;
the apportionment module is configured to determine a die-line file and an image file to be printed on the product blank, the die-line file including a die-line perimeter and a die-line file surface area, and the image file including an image file perimeter and an image file surface area;
the GUI module is configured to display a preview of the die-line file and the image file, in real-time, including a superimposition of the image file surface area on the die-line file surface area such that the image file perimeter is bounded entirely by the die-line perimeter, the GUI module including a cursor configured to allow the user to establish an anchored endpoint adjacent to a crop boundary of the image and to manually move a movable endpoint around the crop boundary;
the path recording module is configured to record a path of the movable endpoint corresponding to a tracing by the user of the crop boundary, the path including a line segment extending from the anchored endpoint to the movable endpoint; and
the shading overlay module is configured to overlay a shading on the image in real time as the user moves the movable endpoint along the path.

2. The system of claim 1, wherein the GUI module further includes a zoom functionality and a pan functionality.

3. The system of claim 1, wherein the cursor is further configured to interact with a pointing device, the pointing device including a member selected from a group consisting of a touch-sensitive screen, a mouse, and a stylus.

4. The system of claim 1, wherein the path recording module is further configured to allow the user to alter the tracing by the user of the crop boundary.

5. The system of claim 1, wherein the shading overlay module is further configured to vary an opacity of the shading based on a proximity of the movable endpoint to the anchored endpoint.

6. The system of claim 1, wherein the memory further comprises a border generation module configured to generate a border extending outwardly from the image file perimeter by a predetermined distance, the border including an area between the image file perimeter and the die-line perimeter.

7. The system of claim 6, wherein the border generation module is further configured to generate a plurality of borders of predetermined widths.

8. The system of claim 6, wherein the border generation module is further configured allow the user to alter the border in real-time.

9. The system of claim 6, wherein the border generation module is further configured to incorporate a decorative pattern within the area between the image file perimeter and the die-line perimeter.

10. The system of claim 1, wherein the GUI module further comprises a geometric element displayable on the GUI module and the movable endpoint is positioned within the geometric element and is movable using the cursor.

11. The system of claim 10, wherein the geometric element is manually centered over the crop boundary by the user and is movable using the cursor.

12. The system of claim 10, wherein the memory further comprises an artificial intelligence module configured to center the geometric element on the crop boundary.

13. The system of claim 1, wherein the GUI module is further configured to interact with a haptic feedback mechanism that provides a physical sensation to the user when the movable endpoint is positioned over a feature within the image.

14. The system of claim 1, wherein the memory further comprises an automatic save feature that saves a progress of the die-line file and the image file.

15. The system of claim 1, wherein the memory further comprises a user profile module configured to store a user preference and a past cropping pattern.

16. A method for cropping an image by a user, the image to be printed on a product blank, comprising:
providing a processor, and a memory in communication with the processor, the memory including a graphical user interface (GUI) module, a communication module, an apportionment module, a path recording module, and a shading overlay module, wherein:
the communication module is configured to receive the image to be printed on the product blank and an identified parameter of the image for the product blank,
the apportionment module is configured to configured to determine a die-line file and an image file to be printed on the product blank, the die-line file including a die-line perimeter and a die-line file surface area, and the image file including an image file perimeter and an image file surface area,
the GUI module is configured to display a preview of the die-line file and the image file, in real-time, including a superimposition of the image file surface area on the die-line file surface area such that the image file perimeter is bounded entirely by the die-line perimeter, the GUI module including a cursor configured to allow the user to establish an anchored endpoint adjacent to a crop boundary of the image and to manually move a movable endpoint around the crop boundary,
the path recording module is configured to record a path of the movable endpoint corresponding to a tracing by the user of the crop boundary, the path including a line segment extending from the anchored endpoint to the movable endpoint, and
the shading overlay module is configured to overlay a shading on the image in real time as the user moves the movable endpoint along the path;
establishing an anchored endpoint adjacent to a crop boundary of the image via the cursor;
permitting the user to manually move the movable endpoint via the cursor around the crop boundary of the image;
generating a line segment between the anchored endpoint and the movable endpoint;
recording a path of the movable endpoint, the path corresponding to a tracing by the user of the crop boundary of the image;
determining an area between the line segment and the path in real time as the user moves the movable endpoint;
overlaying a shading on the area as the user moves the movable endpoint along the path;
displaying an entirety of the area overlayed with the shading when the movable endpoint converges with the anchored endpoint;
generating the image file and the die-line file based on the area overlayed with shading; and
producing a customized printed product based on the image file and the die-line file.

17. The method of claim 16, further comprising:
providing in the memory a border generation module configured to generate a border extending outwardly from the image file perimeter by a predetermined distance, the border including the area between an image file perimeter and the die-line perimeter; and
generating a border extending outwardly from the image file perimeter.

18. The method of claim 16, further comprising:
providing a geometric element displayable on the GUI module;
centering the movable endpoint within the geometric element; and
moving the geometric element via the cursor.

19. The method of claim 16, further comprising:
displaying visual feedback via the shading overlay module, the visual feedback including color changes in the shading when the movable endpoint is positioned over a feature within the image.

20. The method of claim 16, further comprising:
altering a tracing of the crop boundary via the path recording module.
